(19) United States
(12) Patent Application Publication
(10) Pub. No.: US 2009/0123106 A1
(43) Pub. Date: May 14, 2009

(54) THRUST BEARING DEVICE

(76) Inventors: Jerome Boussaguet, Tours (FR); Romuald Lescorail, Saint Cyr Sur Loire (FR); Samuel Viault, Tours (FR); Christophe Houdayer, Semblancay (FR)

Correspondence Address: MEYERTONS, HOOD, KIVLIN, KOWERT & GOETZEL, P.C., P.O. BOX 398, AUSTIN, TX, 78767-0398, US

(21) Appl. No.: 12/143,933

(22) Filed: Jun. 23, 2008

(30) Foreign Application Priority Data
Jul. 4, 2007 (FR) FR 07 56272

(51) Int. Cl. F16C 19/10; B21D 53/10

(52) U.S. Cl. 384/621; 29/898.041

(57) ABSTRACT

Thrust bearing device 1 comprising a first ring 4, a second ring 5, a row of rolling elements 6 arranged between the rings, a cage 7 for retaining the rolling elements 6 and a sleeve 8 for retaining the said rings, the retaining cage 7 and sleeve 8 being produced from deep-drawn sheet metal, the sleeve comprising a retaining portion 8b extending radially outwards, the retaining portion 8b being inscribed within a circle having a diameter substantially equal to the bore of the said cage 7.

The invention relates to the field of thrust bearings, in particular those intended for operating at high temperatures. The invention is concerned, for example, with the thrust bearings used as a support for springs of valves of internal combustion engines. Such valve spring supports are provided to forward the possibility for the supporting turn of the spring to rotate freely with respect to the member on which the said turns exert an axial force. The axial compression of the turns of a helical spring causes namely a slight relative angular displacement between the two ends of the turns. With a view to reducing the friction and to ensuring energy savings in the mechanical assemblies comprising such helical springs, a thrust bearing can be interposed between one end of the spring and the receptacle or the supporting element on which the spring exerts an axial force. The thrust bearings generally used in this type of use are often conventional ball or needle thrust bearings which involve a relatively high outlay in manufacturing terms.

This type of thrust bearing makes it necessary to add an additional retaining member intended for ensuring the non-demountability of the thrust bearing during transport and handling prior to the final installation of the thrust bearing.

Moreover, in the technical field of suspension bearings, the French patent application 2 630 375 discloses a thrust bearing with two rings retained axially by a divisible sleeve produced from elastic material. The sleeve is cut when the rings are being assembled. This type of thrust bearing is unsuitable for uses where it is intended to operate at high temperatures, especially inside an internal combustion engine.

The invention is aimed at remedying the abovementioned disadvantages.

The invention proposes a rolling bearing of reasonable manufacturing cost, which has a small number of components and a low risk of accidental demounting, while withstanding high temperatures.

The rolling bearing device comprises a first ring, a second ring, a row of rolling elements arranged between the rings, a cage for retaining the rolling elements and a sleeve for retaining the said rings. The retaining cage and sleeve are produced from deep-drawn sheet metal. The sleeve comprises a retaining portion extending radially outwards. The retaining portion is inscribed within a circle having a diameter substantially equal to the bore of the said cage.

The retaining portion may or may not also extend axially. The cage and the sleeve may thus come from one common blank, thus making it possible to reduce the number of manufacturing steps and material losses. The metallic cage and sleeve are capable of withstanding the high temperatures, for example higher than 200° C., which are liable to prevail in the compartment of an internal combustion engine.

In one embodiment, the sleeve comprises a substantially axial part fitted into one of the rings. The retaining portion is configured for the axial retention of the other ring. The axial part of the sleeve may be fitted into an axial part of the first ring. The retaining portion of the sleeve may interfere with a substantially radial part of the second ring.

In one embodiment, the first ring comprises a substantially axial part fastened to the sleeve, a substantially radial part forming a bearing seat and a toroidal part forming a raceway for the rolling elements. The substantially radial part may serve as a bearing seat for a spring, for example a valve spring. The spring can come to bear on a face of the second ring which is opposite the rolling elements.

In one embodiment, the second ring comprises a substantially radial part forming a bearing seat, a toroidal part forming a raceway for the rolling elements and a substantially radial part interfering diametrically with the retaining portion of the sleeve.

In one embodiment, the retaining portion comprises an annular collar, the outside diameter of the said collar being substantially equal to the bore of the said cage. The collar may be radial, oblique, toroidal, etc.

In one embodiment, the retaining portion is substantially radial.

In another embodiment, the retaining portion is oblique.

The retaining portion may comprise a plurality of tabs, bulges, bosses, clefts, edges of axial cutouts, etc.

In one embodiment, a mechanical assembly comprises a thrust bearing as described above, arranged between one end of a spring and another element on which the spring exerts an axial force with respect to which the end of the said spring can rotate. The spring can thus be compressed, thus causing a slight rotation of its end turn in contact with the thrust bearing while the other element remains stationary. The mechanical assembly may comprise a suspension member.

In one embodiment, a valve mounting device comprises a thrust bearing as described above, arranged between one end of the spring and another element on which the spring exerts an axial force with respect to which the end of the said spring must be capable of rotating. The valve stem can pass through the thrust bearing. The thrust bearing may have a diameter of the order of 40 to 50 mm.

The method for manufacturing a thrust bearing comprises the formation of a common sheet-metal sleeve/cage blank. The common blank comprises a substantially axial part, a substantially radial part and an oblique part provided with cells. The method also comprises the circular cutting-out of the substantially radial part of the blank in two parts, an outer part belonging to the cage and an inner part belonging to the sleeve.

Advantageously, the outer part forms the cage.

Advantageously, the inner part forms the sleeve. Cutting-out may be carried out on a press.

In one embodiment, the cage is arranged in one of the rings, and the rolling elements are arranged in the cells of the cage. The cage then ensures their regular circumferential distribution, making it possible to transfer suitably distributed axial forces and to prevent the friction of one rolling element on another.

In one embodiment, the other ring is placed on the rolling elements.

In one embodiment, the sleeve is driven in an axial movement. The axial part of the sleeve passes through the other ring. The axial part of the sleeve is fitted into an axial part of the first ring. The substantially radial part of the sleeve, forming a collar towards the outside, blocks the second ring axially by interfering diametrically with the substantially radial portion of small diameter of the first ring.

The thrust bearing thus formed has a low risk of accidental demounting. The length by which the sleeve is fitted into the first ring may be set as a function of the demounting risk. The thrust bearing can subsequently be arranged between a receptacle and a spring.

The thrust bearing comprises rings produced from sheet metal of substantially constant thickness, a sleeve and a cage likewise produced from sheet metal from the same sheet-metal blank. The cutting-out of the common blank of the sleeve and of the cage proves particularly economical in that it can be carried out on a press without any significant loss of material.

The present invention will be understood more clearly from a study of the detailed description of some embodiments taken as in no way limiting examples and illustrated by the accompanying drawings in which:

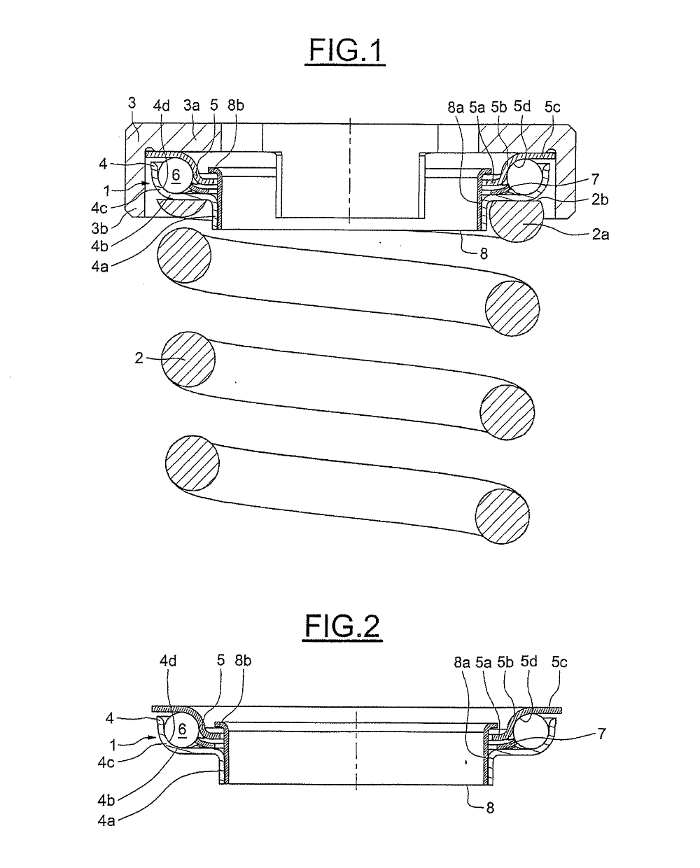

FIG. 1 is an axial sectional view of a thrust bearing in the mounted state;

FIG. 2 is an axial sectional view of the thrust bearing;

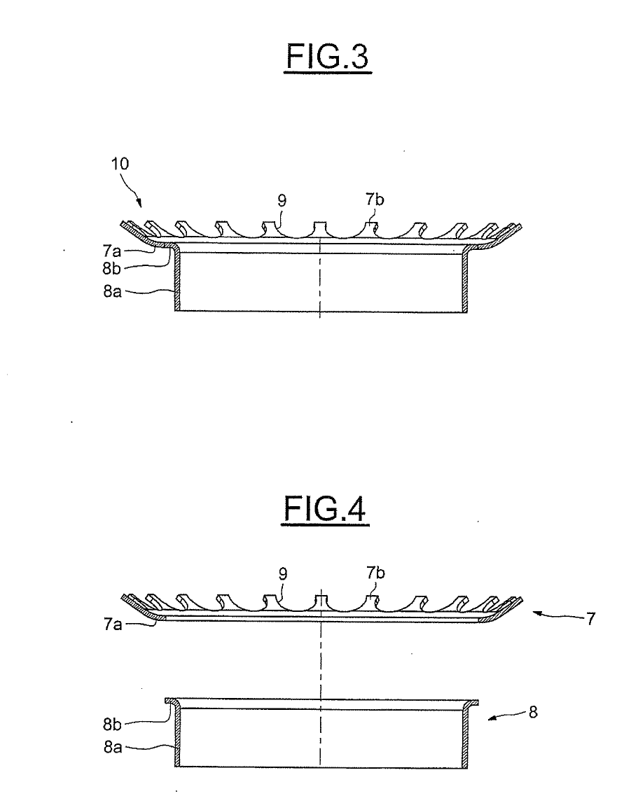

FIG. 3 is a view of the common blank before cutting-out; and

FIG. 4 is a view of the cage and of the sleeve after the cutting-out of the common blank.

As can be seen in FIG. 1, a thrust bearing 1 is arranged between a spring 2 and a receptacle 3. The spring 2 has an upper turn 2a having a substantially planar upper surface 2b. The spring 2 is of the helical type and can be produced from suitable steel. The receptacle 3 is in the general form of an annular pan with a radial part 3a, provided with a lower surface in contact with the thrust bearing 1, and an outer axial rim 3b extending downwards and ensuring that the thrust bearing 1 is centred and maintained in a radial position.

The thrust bearing 1 comprises a first ring 4, here in the lower position, a second ring 5, here in the upper position, and a row of rolling elements 6, for example balls, arranged between the rings 4 and 5. The thrust bearing 1 likewise comprises a cage 7 ensuring that the regular circumferential spacing of the rolling elements 6 is maintained, and a sleeve 8 for maintaining the rings 4 and 5 axially.

The first ring 4 comprises a substantially axial part 4a in contact with the sleeve 8 and arranged within the upper turn 2a of the spring 2. The first ring 4 likewise comprises a substantially radial part 4b resting on the upper surface 2b of the end turn 2a of the spring 2. The first ring 4 comprises a toroidal part 4c provided with an upper surface forming a raceway 4d for the rolling elements 6. The substantially axial part 4a extends downwards from the end of small diameter of the substantially radial part 4b. The toroidal part 4c extends upwards and outwards from the edge of large diameter of the substantially radial part 4b.

The second ring 5 comprises a substantially radial part of small diameter 5a, a toroidal part 5b and a substantially radial part of large diameter 5c. The toroidal part 5b is provided with a lower surface forming a raceway 5d for the rolling elements. The raceways 4d and 5d ensure oblique contact. In other words, the raceways 4d and 5d are arranged on one side and the other of an imaginary circle passing through the centre of the rolling elements 6. The substantially radial part of small diameter 5a extends from the inner edge of the toroidal part 5b. The substantially radial part of large diameter 5c extends outwards from the upper edge of large diameter of the toroidal part 5b.

The upper surface of the substantially radial part 5c is in bearing contact against the radial part 3a of the receptacle 3. The end of the substantially radial part 5c is in contact against the bore of the rim 3b of the receptacle 3. The thrust bearing 1 is thus maintained axially and radially in the receptacle 3. The radial part of small diameter 5a has a bore larger than the bore of the substantially axial part 4a of the first ring 4.

The cage 7 comprises an annular heel 7a arranged axially between the substantially radial part of small diameter 5a of the second ring 5 and the substantially radial part 4b of the first ring 4. The cage 7 also comprises a plurality of teeth or tongues 7b between which are defined the cells 9 in which the rolling elements 6 are arranged. The heel 7a may be radial or slightly oblique. The teeth 7b extend obliquely outwards and upwards. The cage 7 may be produced from steel or from brass.

The sleeve 8 is in the form of an annular pan of L-shaped cross section. The sleeve 8 comprises a substantially axial part 8a and a collar 8b extending radially outwards from one end of the substantially axial part 8a. The collar 8b is substantially radial. The substantially axial part 8a of the sleeve 8 is fitted into the bore of the substantially axial part 4a of the first ring 4. The substantially axial part 8a of the sleeve 8 has a length markedly greater than that of the substantially axial portion 4a of the first ring 4, in such a way that the collar 8b leaves an axial space between the said collar 8b and the substantially radial part 4b of the first ring 4. The heel 7a of the cage 7 and the substantially radial part of small diameter 5a of the second ring 5 are arranged in the said axial space. The collar 8b may be arranged slightly above the radial plane passing through the centre of the rolling elements.

The outside diameter of the collar 8b is substantially equal to the bore of the cage 7. Thus, the cage 7 and the sleeve 8 can be manufactured from the same blank. The outside diameter of the collar 8b of the sleeve 8 is greater than the bore of the substantially radial part 5a of the second ring 5. Any movement for demounting the second ring 5 is blocked by the collar 8b. This ensures the non-demountability of the thrust bearing 1 in its state illustrated in FIG. 2, that is to say before mounting between the spring 2 and the receptacle 3 illustrated in FIG. 1, thus making it possible to handle the said thrust bearing without difficulty.

The mounting of the thrust bearing in the state illustrated in FIG. 2 can be carried out by arranging the cage 7 in one of the rings, for example the first ring 4, and by arranging the rolling elements 6 in the cells 9 of the cage 7, then by bringing the second ring 5 onto the rolling element 6 and then fitting the sleeve 8 into the bore of the first ring 4, while at the same time causing it to pass inside the second ring 5 and the cage 7, the substantially radial part of small diameter 5a of the second ring 5 being arranged axially between the collar 8b of the sleeve 8 and the fitting zone of the sleeve 8 in the first ring 4, without the collar 8b coming into contact with the second ring 5.

The cage 7 and the sleeve 8 can be manufactured as follows. A common blank 10, illustrated in FIG. 3, is formed. The common blank 10 is produced by cutting out and deep-drawing a sheet-metal, for example sheet-steel blank. The common blank 10 comprises a substantially axial part 8a, a substantially radial part, common to the substantially radial parts 8b and 7a and the teeth 7b. The cells 9 may have been formed beforehand by being cut out on a press.

The blank 10 is subsequently cut into two parts, see FIG. 4, forming respectively the cage 7 and the sleeve 8. Cutting-out may be carried out on a press by means of suitable tools and may take place with material being preserved, inasmuch as the bore of the cage 7 is equal to the outside diameter of the collar 8b of the sleeve 8.

The thrust bearing 1 is particularly suitable for uses at high temperatures. Since the rings 4 and 5, the rolling elements 6, the cage 7 and the sleeve 8 are metallic. The rings 4 and 5 may be produced by deep-drawing from sheet steel, which proves economical. The thrust bearing being metallic is therefore capable of withstanding temperatures higher than 200° C. These temperatures may commonly be encountered in the vicinity of the valves of an internal combustion engine. The presence of a thrust bearing at the end of a valve spring makes it possible to reduce the friction and, consequently, the heating of the engine. The reduction of friction also makes it possible to reduce the fuel consumption. The thrust bearing is suitable for cooperating with a spring, in other uses, especially as a suspension thrust bearing.

The sleeve produced from the same blank as the cage proves particularly economical and makes it possible to avoid the presence of complex components for holding the two rings of the thrust bearing together or else of disposable components which prove costly and have to be recycled. The ball thrust bearing device thus produced is easy and economical to manufacture and is highly compact and light-weight, thus reducing the inertias and assisting the variations in operating conditions of the internal combustion engine. The invention thus allows a reduction in mass, a lowering of energy consumption and a lessening of the heating of components, while reducing to a minimum the risks of the loss of components prior to assembly.

1. Thrust bearing device (1) comprising a first ring (4), a second ring (5), a row of rolling elements (6) arranged between the rings, a cage (7) for retaining the rolling elements (6) and a sleeve (8) for retaining the said rings, the retaining cage (7) and sleeve (8) being produced from deep-drawn sheet metal, and the sleeve (8) comprising a retaining portion (8b) extending radially outwards, characterized in that the retaining portion (8b) is inscribed within a circle having a diameter substantially equal to the bore of the said cage (7).

2. Device according to claim 1, in which the sleeve (8) comprises an axial part (8a) fitted into the first ring (4), the retaining portion (8b) being configured for the axial retention of the second ring (5).

3. Device according to claim 1 or 2, in which the first ring (4) comprises an axial part (4a) fastened to the sleeve (8), a radial part (4b) forming a bearing seat and a toroidal part (4c) forming a raceway.

4. Device according to any one of the preceding claims, in which the second ring (5) comprises a substantially radial part (5c) forming a bearing seat, a toroidal part (5b) forming a raceway for the rolling elements and a substantially radial part (5a) interfering diametrically with the retaining portion (8b) of the sleeve (8).

5. Device according to any one of the preceding claims, in which the retaining portion (8b) comprises an annular collar, the outside diameter of the said collar being substantially equal to the bore of the said cage (7).

6. Device according to any one of the preceding claims, in which the retaining portion (8b) is substantially radial.

7. Mechanical assembly comprising a thrust bearing (1) according to any one of the preceding claims, arranged between one end of a spring (2) and another element (3) on which the spring exerts an axial force and with respect to which the end of the said spring can rotate.

8. Valve mounting device comprising a thrust bearing (1) according to any one of claims 1 to 6, arranged between one end of a spring (2) and another element (3) on which the spring exerts an axial force and with respect to which the end of the said spring can rotate.

9. Method for manufacturing a thrust bearing, characterized in that:
a common sheet-metal sleeve/cage blank is formed, the common blank comprising an axial part, a substantially radial part and an oblique part provided with cells,
the substantially radial portion of the blank is cut circularly into two parts, an outer part being intended for forming the cage and an inner part being intended for forming the sleeve,
the cage thus formed is arranged in one of the rings and the rolling elements are arranged in the cells of the cage,
the other ring is placed on the rolling elements,
the sleeve thus formed is driven in an axial movement, the axial part of the sleeve passing through the other ring and being fitted into an axial part of the first ring, the substantially radial part of the sleeve blocking the second ring axially.
